(19) United States
(12) Patent Application Publication
(10) Pub. No.: US 2023/0057477 A1
(43) Pub. Date: Feb. 23, 2023

(54) WORKING FLUID SYSTEM MONITORING BASED ON HEAT EXCHANGER PARAMETERS

(71) Applicant: DraCool DataPlate, LLC, Carlisle, OH (US)

(72) Inventors: Caleb Avendano, Monroe, OH (US); Xavier Avendano, Lebanon, OH (US)

(21) Appl. No.: 17/891,698

(22) Filed: Aug. 19, 2022

Related U.S. Application Data
(60) Provisional application No. 63/234,826, filed on Aug. 19, 2021.

(51) Int. Cl. F28F 27/00

(52) U.S. Cl. CPC F28F 27/00; F28F 2200/00; F28F 2265/18

(57) ABSTRACT

A system and method determine a heat exchanger efficiency of a fluid that flows through a heat exchanger included in a working fluid system. Characteristics of a fluid are monitored in real-time as the fluid flows through the flow path of a heat exchanger. A fluid status is determined in real-time that is associated with a plurality of heat exchange parameters of the fluid as the fluid flows through the flow path of the heat exchanger that is determined from the heat exchanger parameters detected by the fluid monitoring device. A corrective action is determined in real-time when the fluid status of the fluid indicates that the corrective action is to be executed to prevent damage to the working fluid system and an assessment is generated of the corrective action that is to be executed based on the heat exchanger parameters detected by the fluid monitoring device.

### FIELD OF THE INVENTION

This application claims the benefit of U.S. Provisional Application No. 63/234,826 filed on Aug. 19, 2021, which is incorporated herein by reference in its entirety.

### FIELD OF THE INVENTION

The present invention relates generally to fluid circuits and, more particularly, to generating the operating condition of a fluid in the fluid circuit.

### BACKGROUND OF THE INVENTION

Industrial systems often times utilize a working fluid to perform work and/or processing systems often times process a working fluid to generate a product. A working fluid system is a system that propagates a fluid through the system to execute an action and/or to process a fluid. For example, working fluid systems implement a working fluid to perform work, such as, to run hydraulic motors to extend and retract cylinders in various manufacturing or production environments. These working fluid systems include fluids, such as hydraulic fluid, to maneuver the components of the fluid power fluid system, such as the machine, in executing the desired work. As the fluid pushes through the working fluid system whether to execute work an action such as in an industrial system and/or process a fluid such as in a processing system, the fluid typically flows through one or more heat exchangers.

For example, as the fluid pushes through the working fluid system as the working fluid system executes the desired action and/or processes the desired fluid, the fluid flows through one or more heat exchangers. A fluid status of the fluid may deviate as the fluid may be tainted with numerous types of impacts from the working fluid system. For example, the metallic wear debris included in the fluid may increase as the working fluid system operates and an increase in the metallic wear debris in the fluid may impact the performance of the working fluid system as well as cause wear and/or damage to the components of the working fluid system should the fluid and/or the components of the working fluid system not be treated for the increase of metallic wear debris included in the fluid. In performing corrective action to the fluid to improve the fluid status of the fluid, the efficiency in which the working fluid system operates increases as well as prevents and/or slows down the mechanical wear of several of the components of the working fluid system.

Typically, the fluid flows through one or more heat exchangers as the one or more heat exchangers are paramount in the operation of the working fluid systems. As a result, the fluid and the heat exchanger may be monitored as the fluid flows through the heat exchanger thereby generating heat exchanger parameters. Corrective action to the fluid may be any type of action that addresses the heat exchanger parameters as monitored of the fluid and the heat exchanger as the fluid flows through the heat exchanger that are negatively impacting the fluid status of the fluid. However, a failure to implement the corrective action to adequately address the heat exchanger parameters that are negatively impacting the fluid status of the fluid may result in the components of the working fluid system to eventually fail if the quality of the fluid is not increased.

Failure of the working fluid system can have catastrophic consequences. For example, if a pump included in the working fluid system abruptly fails, substantial debris can be introduced into the system causing damage to downstream components. In addition, catastrophic failures can result in substantial disruption of the manufacturing process. In view of the consequences of failure in components of the working fluid system, it is desirable to determine in real-time when the fluid status of the fluid indicates that a corrective action is to be executed to increase the quality of the fluid and to execute the corrective action to increase the quality of the fluid. In increasing the quality of the fluid when the fluid status of the fluid is negatively impacted by various heat exchanger parameters, the quality of the fluid may be adequately increased, thus avoiding a major disruption in production.

One problem, however, is how to objectively determine how to evaluate the quality of the fluid as well as the status of the heat exchanger. Generally, preventive maintenance schedules are developed from past experience and are subjective. Because fluid wear cannot be easily monitored during operation, the decline in the performance of the fluid and/or heat exchanger to adequately improve the quality of the fluid may not be easily predicted. In this regard, the heat exchanger parameters of the fluid and/or heat exchanger that are negatively impacting the fluid status of the fluid continue to have an increased negative impact on the fluid. The quality of the fluid may continue to decrease as the heat exchanger parameters negatively impacting the fluid status of the fluid remain unchecked. By determining the heat exchanger parameters that are negatively impacting the fluid status of the fluid and/or and in turn determining corrective actions to be executed to remedy the heat exchanger parameters negatively impacting the fluid, the appropriate corrective actions may then be executed to increase the quality of the fluid before a decrease in the performance in the working fluid system occurs and/or the components of the working fluid system suffer wear and/or damage and/or the product generated by the working fluid system is tainted and is required to be discarded.

### SUMMARY OF THE INVENTION

The present invention overcomes the foregoing and other shortcomings and drawbacks of known fluid monitoring devices for use in fluid circuits. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a computer implemented method determines a heat exchanger efficiency of a fluid that flows through a heat exchanger included in a working fluid system. A plurality of characteristics of a fluid on a flow path is monitored as the fluid flows through the flow path of a heat exchanger included in the working fluid system by a fluid monitoring device that is coupled to the heat exchanger. The flow path is a path that the fluid flows through the heat exchanger and is monitored by the fluid monitoring device that is coupled to the heat exchanger as the fluid flows through the heat exchanger of the working fluid system. A fluid status is determined in real-time that is associated with a plurality of heat exchanger parameters of the fluid as the fluid flows through the flow path of the heat exchanger that is determined from the plurality of heat exchanger parameters detected by the fluid monitoring device. A corrective action that is to be executed to increase a quality of a fluid is determined in real-time when the fluid status of the fluid indicates that a corrective action is to be executed based on the heat exchanger parameters detected by the fluid monitoring device as the fluid flows through the heat exchanger. Degradation to components of the working fluid system increases as the fluid flows through the heat exchanger without the corrective action being executed to the working fluid system.

According to another aspect of the present invention, a system for determining a heat exchanger efficiency of a fluid that flows through a heat exchanger in a working fluid system includes a fluid monitoring device and a fluid computing device. The fluid monitoring device is coupled to the heat exchanger and is configured to monitor in real-time a plurality of characteristics of a fluid on a flow path as the fluid flows through the flow path of the heat exchanger included in the working fluid system. The flow path is a path that the fluid flows through the heat exchanger and is monitored by the fluid monitoring device as the fluid flows through the heat exchanger of the working fluid system. A fluid computing device is configured to determine a fluid status in real-time that is associated with a plurality of heat exchanger parameters of the fluid as the fluid flows through the flow path of the heat exchanger that is determined from the plurality of heat exchanger parameters detected by the fluid monitoring device. The fluid computing device is also configured to determine in real-time when the fluid status of the fluid indicates that a corrective action is to be executed to increase a quality of a fluid based on the heat exchanger parameters detected by the fluid monitoring device as the fluid flows through the heat exchanger. Degradation to components of the working fluid system increases as the fluid flows through the heat exchanger without the corrective action being executed to the working fluid system.

The above and other objectives and advantages of the present invention shall be made apparent from the accompanying drawings and description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiments given below, serve to explain the principles of the invention.

FIG. 1 is a schematic view of a working fluid system according to one embodiment of the invention.

FIG. 2 is schematic view of a fluid computing configuration according to one embodiment of the invention.

FIG. 3 is a schematic view of an example visual graph configuration in which the fluid computing device displays a visual graph of the density of the fluid via the user interface of the fluid monitoring computing device according to one embodiment of the invention.

FIG. 4 is a schematic view of an example threshold alert configuration in which the fluid monitoring computing device displays a status of several heat exchanger parameters of the fluid with regards to whether the heat exchanger parameters have exceeded or deviated below their respective thresholds via the user interface according to one embodiment of the invention.

FIG. 5 is a flowchart of an exemplary process for determining a heat exchanger efficiency of a fluid that flows through a heat exchanger included in a working fluid system according to one embodiment of the invention.

### DETAILED DESCRIPTION OF THE INVENTION

In the Detailed Description herein, references to “one embodiment”, “an embodiment”, an “example embodiment”, etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment of the present invention, Applicants submit that it may be within the knowledge of one skilled in the art to affect such feature, structure, or characteristic in connection with other embodiments of the present invention whether or not explicitly described.

Embodiments of the present invention may be implemented in hardware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, each of the various components discussed can be considered a module, and the term “module” shall be understood to include at least one software, firmware, and hardware (such as one or more circuit, microchip, or device, or any combination thereof), and/or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further components within a module can be in a single device or distributed among multiple devices in a wired or wireless manner.

The following detailed description refers to the accompanying drawings that illustrate exemplary embodiments of the present invention. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the present invention to the embodiments described below.

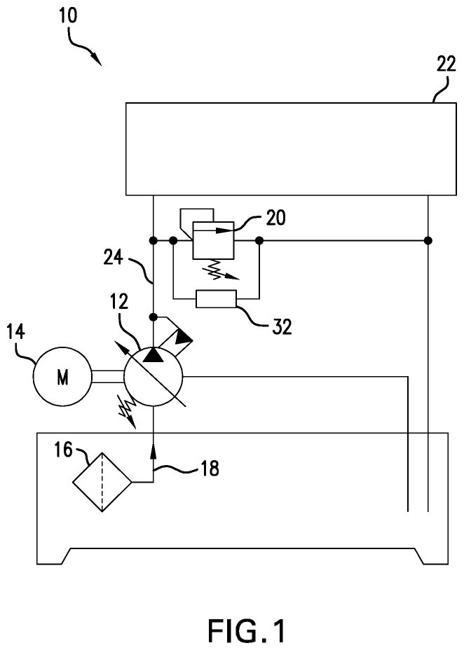

With reference to FIG. 1, an exemplary working fluid system 10 is depicted. In this example, the working fluid system 10 may include a variable speed hydraulic pump 12 powered by a motor 14. During operation, the pump 12 may draw fluid through a heat exchanger 20. The heat exchanger 20 may then transfer heat from the fluid to decrease or increase the temperature of the fluid as the fluid flows through the heat exchanger 20. The fluid that flows through the working fluid system 10 enables the components of the working fluid system 10 to operate. For example, the variable speed hydraulic pump 12 pumps the fluid throughout the working fluid system 10 such that the fluid flows through the machine 22 and powers the machine 22 to execute the operations of the machine 22. The fluid then flows out of the machine 22 and into the heat exchanger 20 to be recirculated back through the working fluid system 10 again and again as the working fluid system 10 operates. Components of the working fluid system 10 includes each of the components that operate in order for the working fluid system 10 to execute the appropriate actions to achieve the objective of the working fluid system 10 which includes but is not limited to the fluid and/or other fluids that flow through the working fluid system 10 and/or the fluid that is produced as a product by the working fluid system 10. The components may further include the fluid pump 12, the case drain, the fluid filter 16, the motor 14, the machine 22, the heat exchanger 20, and/or any other component including any fluid that operate in order for the working fluid system 10 to execute the appropriate actions to achieve the objective of the working fluid system 10 that will be apparent to those skilled in the relevant art(s) without departing from the spirit and scope of the disclosure.

As noted above, a working fluid system is a system that propagates a fluid through the system to execute an action and/or to process a fluid. The action may be an action that is executed by the working fluid system in order to accomplish the objective of the working fluid system and the flow of the fluid through the working fluid system is required for the working fluid system to execute the action to accomplish the objective. In the example above and discussed further below, with regard to the working fluid system 10, the action is the machine executing the action that the machine is required to execute to accomplish the objective of the machine and the flow of the fluid is required working fluid system 10 is a working fluid system in which the fluid powers the machine to execute the action to accomplish the objective.

However, the working fluid system may also be other industrial systems that propagate a fluid through the system to execute the action to accomplish the objective. In another example, the working fluid system may be an industrial HVAC system in which fluid flows through the HVAC system and at least one heat exchanger is required to cool and/or heat the fluid as the HVAC system operates. In another example, the working fluid system may be a processing system that processes a fluid such as a chemical processing system in which the chemical processing system processes a fluid to ultimately generate a product from the fluid in which the fluid flows through at least one heat exchanger during the chemical processing. In another example, the working fluid system may be a processing system for food and beverage in which several fluids may implemented to generate a liquid product that is then consumed.

The working fluid system may be an industrial system, a working fluid system, a space heating system, a refrigeration system, an air conditioning system, a HVAC system, power station, a processing system, chemical processing system, petrochemical processing system, petroleum refineries, natural-gas processing, sewage treatment, food and beverage and/or any other type of working fluid system that propagates a fluid through the system to execute an action and/or to process a fluid that will be apparent to those skilled in the relevant art(s) without departing from the spirit and scope of the disclosure. The example above with regard to the heat exchanger incorporated into the working fluid system 10 which is a working fluid system is continued below for the ease of discussion. However, the heat exchanger 20 and the fluid monitoring device 32 as well as the fluid computing device 210 discussed below may be incorporated into any type of working fluid system that will be apparent to those skilled in the relevant art(s) without departing from the spirit and scope of the disclosure.

For example, the fluid when flowing through the working fluid system 10 may collect varnish as the working fluid system 10 operates. Varnish may be collected in the fluid from the pipes of the working fluid system 10 that the fluid flows as well as from the machine 22. As the machine 22 operates, the machine may generate varnish which is then collected in the fluid. As the fluid collects varnish, the density of the fluid increases thereby decreasing the effectiveness of the heat exchanger 20 as the fluid with an increased density of varnish may slowly clog the heat exchanger 20 and negatively impact the components of the working fluid system 10, such as the heat exchanger 20, the machine 22 and the pump 12. However, the fluid with decreased levels of varnish provides a fluid that more easily flows through the heat exchanger 20 and positively impacts the performance of the working fluid system 10.

In another example, the heat exchanger 20, the pump 12, and the machine 22 may be valuable components of the working fluid system 10 in that the heat exchanger 20, the pump 12, and the machine 22 may execute the operations necessary to maintain the working fluid system 10 to complete the designated tasks, such as functioning on a manufacturing line. The fluid is pumped by the pump 12 and circulated through the machine 22 such that the machine 22 may execute the operations with the circulation of the fluid and the heat exchanger 20 transfers heat from the fluid to decrease or increase the temperature of the fluid as necessary. Particles may be accumulated into the fluid as the fluid flows through the different components of the working fluid system 10. Such particles that accumulate in the fluid may significantly impact the operation of the components, such as the heat exchanger 20, the pump 12 and the machine 22, as the fluid flows through those components with the accumulated particles. Eventually, the particles may accumulate in the fluid to a point where the increased accumulation of the particles may trigger wear and/or damage the components of the working fluid system 10 as the particles continue to accumulate.

Further, the fluid as the fluid flows through the heat exchanger 20 of the working fluid system 10 may be an indicator as to an overall status of the working fluid system 10. Since the fluid flows throughout the heat exchanger 20 and flows through each of the components of the working fluid system 10, the fluid may be impacted when the performance of different components of the working fluid system 10 may begin to decrease. A fluid status of the fluid may be a status of the fluid that is indicative as to how the fluid is being impacted by the operation of the working fluid system 10 as the fluid flows through the heat exchanger 20. As the fluid flows through the heat exchanger 20 of the working fluid system 10 during operation of the working fluid system 10, different heat exchanger parameters of the fluid may be impacted as the fluid flows through the heat exchanger 20 thereby impacting the fluid status of the fluid. The heat exchanger parameters may be measurable parameters of the fluid that may fluctuate as the fluid flows through the heat exchanger 20 due to the impact on the fluid by the operation of the working fluid system 10.

For example, as the fluid flows through the working fluid system 10 during the operation of the working fluid system 10, wear metals included in the fluid may increase. An in increase in wear metals in the fluid may decrease the effectiveness of the heat exchanger 20 as the fluid may then circulate the wear metals through the heat exchanger 20 of the working fluid system 10 as well as the components of the working fluid system 10 and thereby decreasing the performance of the working fluid system 10 and causing wear and/or damage to the components of the working fluid system 10. However, an increase in wear metals in the fluid is also an indicator that a portion and/or component of the working fluid system 10 is malfunctioning. An increase of wear metals in the fluid is being triggered by some aspect of the operation of the working fluid system 10 and that aspect is beginning to malfunction due to the increase of wear metals in the fluid.

In such an example, the increase of wear metals in the fluid may be caused by an increase of vibration by a component of the working fluid system 10. The vibration by the component of the working fluid system 10 is a malfunction in the operation of the working fluid system 10. Often times, an increase in the wear metals of the fluid due to an increase in vibration of the component of the working fluid system 10 may occur before the vibration may even be detectable by a user. Thus, an increase in the wear metals in the fluid as the fluid flows through the heat exchanger 20 may be an indicator that an increase in vibration of the component is occurring and the user may then examine the components of the working fluid system 10 with regard to resolving the increase in vibration before any negative impact to the working fluid system 10 is suffered and/or damage to the vibrating component is incurred.

Degradation to the components of the working fluid system 10 may increase when the fluid status of the fluid indicates that a decrease in the effectiveness of the heat exchanger 20 is occurring based on the heat exchanger parameters of the fluid as the fluid flows through the heat exchanger 20. The degradation to the components may continue to increase if the fluid continues to flow through the working fluid system 10 with the decreased effectiveness of the heat exchanger 20 and without any corrective action being executed to increase the effectiveness of the heat exchanger 20. As noted above, the fluid status of the fluid may be an indicator as to the effectiveness of the heat exchanger 20 based on the different heat exchanger parameters of the fluid that may be measured as the fluid flows through the heat exchanger 20. Continuing to allow the fluid to flow through the working fluid system 10 when the fluid status indicates that the effectiveness of the heat exchanger 20 is decreasing without executing any corrective action to increase the effectiveness of the heat exchanger 20 may simply further increases the decrease in the performance of the working fluid system 10 as well as the increase in the wear and/or damage caused to the components.

Rather, determining a corrective action and an assessment of the corrective action that may be executed to improve the fluid status of the fluid such that the effectiveness of the heat exchanger 20 increases may be remedial action that enables the working fluid system 10 to continue to operate with lessened negative impact on the performance of the working fluid system 10 as well as the wear and/or damage caused to the components. The heat exchanger parameters of the fluid as the fluid flows through the heat exchanger 20 as measured may provide indicators as to the type of corrective action that is to be executed in order to improve the fluid status of the fluid and thereby increasing the effectiveness of the heat exchanger 20. Each heat exchanger parameter may be directed to a root cause of malfunction of the working fluid system 10 and thereby provide a corrective action to remedy the root cause of the working fluid system 10.

For example, the heat exchanger parameter of varnish included in the fluid may continue to increase and thereby trigger the fluid status of the fluid to decrease indicating a decrease in the effectiveness of the heat exchanger 20. An increase in the heat exchanger parameter of varnish included in the fluid may trigger a corrective action to execute a re-additization of the fluid such that solubility additives may be added into the fluid. The addition of the solubility additives into the fluid may dissolve the varnish included in the fluid as well as the varnish included in the components of the working fluid system 10. In doing so, the fluid status of the fluid may increase due to an increase in the effectiveness of the heat exchanger 20 that is triggered by the execution of the corrective action in adding solubility additives into the varnish to decrease the varnish included in the fluid.

The determination of the fluid status of the fluid in real-time monitoring may enable the heat exchanger parameters of the fluid to be continuously monitored as the fluid flows through the heat exchanger 20. In monitoring the heat exchanger parameters of the fluid as the fluid continuously flows through the heat exchanger 20 may enable the heat exchanger parameters to be monitored in real-time as the working fluid system 10 operates and thereby to identify any heat exchanger parameter that may deviate and be an indicator that the fluid status of the fluid is decreasing. In doing so, any indication that the fluid status is decreasing may be executed in real-time monitoring and thereby the appropriate corrective action to be executed to increase the fluid status of the fluid may also be determined in real-time monitoring such that the decrease in the fluid status of the fluid may be adequately addressed. Real-time monitoring may be the measuring of the heat exchanger parameters as the fluid continuously flows through the heat exchanger 20 as the working fluid system operates and thus any determination of the fluid status of the fluid may also be executed as the heat exchanger parameters of the fluid fluctuate.

In this regard and in one embodiment of the invention, a fluid monitoring device 32 is coupled to the heat exchanger 20 to measure a characteristic of the fluid flow. Fluid flow incorporates how a fluid flows throughout the working fluid system 10. For example, a pressure change in which the fluid flows through the heat exchanger 20 as determined by the pressure of the fluid as measured and then the difference in the pressure of the fluid as measured. The pressure change in fluid flow may remain consistent for each cycle of the machine 22. The pressure change of the fluid flow at the heat exchanger 20 is an indicator of the particle absorption level of the fluid filter 16. However, degradation in the performance of the fluid filter 16 may cause the pressure change of the fluid flow at the heat exchanger 20 to increase to a threshold level that is indicative that the fluid filter 16 has reached the particle absorption saturation level.

The characteristic of fluid flow may be an identifiable parameter of the fluid flow that may be measured by the fluid monitoring device 32 and/or derived from other characteristics and/or combination of characteristics measured by the fluid monitoring device 32. The fluid monitoring device 32 may monitor one or more characteristics of the fluid as the fluid passes through the heat exchanger 20. Characteristics of the fluid flow whether measured by the fluid monitoring device 32 and/or derived from other characteristics measured by the fluid monitoring device 32 may be indicative as to the performance of the heat exchanger 20 of the working fluid system 10. As the performance of the heat exchanger 20 degrades, the characteristics may provide an indication that the performance of the heat exchanger 20 is degrading and/or to the rate in which the performance of the heat exchanger 20 is degrading.

For example, the temperature change of the fluid as the fluid flows through the heat exchanger 20 and the percentage of water saturation of the fluid as the fluid flows throughout the heat exchanger 20 may be indicative as to the performance of the heat exchanger 20 of the working fluid system 10. The temperature change of the fluid and the saturation of the fluid as the fluid flows through the heat exchanger 20 may be heat exchanger parameters of the fluid that may not only be indicative as to the fluid status of the fluid but may also be indicative as to components of the working fluid system 10 that may be malfunctioning and triggering the fluid status of the fluid to decrease thereby causing the effectiveness of the heat exchanger 20 to decrease. In such an example, the temperature change of the fluid may decrease as the fluid flows through the heat exchanger 20 while the saturation of the fluid may increase as the fluid flows through the heat exchanger 20. Such a decrease in the temperature change coupled with an increase in saturation of the fluid as the fluid flows through the heat exchanger 20 may be indicative that a corrective action directed to evaluating the heat exchanger 20 of the working fluid system 10 is to be executed in order to prevent an impact on the performance of the working fluid system 10 as well as wear and/or damage to additional components of the working fluid system 10.

The characteristics and/or heat exchanger parameter of fluid flow that may be monitored by the fluid monitoring device 32 and/or heat exchanger parameters derived from characteristics monitored by the fluid monitoring device 32 by the fluid computing device 210 may include but are not limited to the pressure change, flow rate, volume, temperature change, pump efficiency, viscosity, thermal properties, Reynolds number, particle count, relative humidity, viscosity, density, dielectric properties, AC conductivity, permittivity, pressure, wear metals level, varnish level, saturation level, cross-contamination level, vibration, magnetic flux gradient and/or any other type of characteristic that may be an identifiable heat exchanger parameter of the fluid that will be apparent to those skilled in the relevant art(s) without departing from the spirit and scope of the disclosure.

The fluid monitoring device 32 may monitor the characteristic of the fluid flow at a first point and a second point on a flow path of the heat exchanger 20. The flow path is a path that the fluid flows through the heat exchanger 20 and is monitored by the fluid monitoring device 32 as the fluid flows through the heat exchanger 20. For example, the flow path includes the path of the fluid from a first point that is an input of the heat exchanger 20 in which the fluid flows into the heat exchanger 20 and a second point that is an output of the heat exchanger 20 in which fluid flows out of the heat exchanger 20. As the fluid flows through heat exchanger 20 and monitored by the fluid monitoring device 32, differences between the characteristic as monitored by the fluid monitoring device 32 at the first point and then the second point may be indicative as the fluid status of the fluid in real-time.

The fluid is circulated throughout the working fluid system 10 when driving the machine 22. The fluid monitoring device 32 may monitor numerous heat exchanger parameters that are detected from the characteristics of the fluid as the fluid is circulated through the heat exchanger 20. The fluid monitoring device 32 may monitor the numerous heat exchanger parameters based on different sensors included in the fluid monitoring device 32 as coupled to the heat exchanger 20. The heat exchanger parameters may be derived from the characteristics measured from the fluid in which the fluid computing device 210 may determine the heat exchanger parameter from the characteristics measured by the fluid monitoring device 32. For example, the fluid computing device 210 may determine the cross-contamination of a fluid from different characteristics of the fluid as measured by the fluid monitoring device 32 such as but not limited to density and vibration. However, the heat exchanger parameters may also include characteristics of the fluid as directly measured by the fluid monitoring device 32 and no conversion is needed by the fluid computing device 210. For example, heat exchanger parameters may include but are not limited density, vibration and so on as measured by the fluid monitoring device 32.

In doing so, the characteristics of the fluid may be assessed in real-time as the fluid is circulated through the heat exchanger 20 and the different heat exchanger parameters are triggered from the characteristics of the fluid changing in real-time. Different components of the working fluid system 10 may then be identified by the assessment of the different heat exchanger parameters triggered by the characteristics of the fluid that are impacted by the different heat exchanger parameters. As noted above, the heat exchanger parameters that impact the fluid status of the fluid not only impact the effectiveness of the heat exchanger 20 but may also result from the operation of different components of the working fluid system 10 that have begun to malfunction. Thus, the identification of heat exchanger parameters that deviate in the fluid as the fluid flows through the heat exchanger 20 and decrease the fluid status of the fluid may trigger remedial actions to be taken to address the different components of the working fluid system 10 that may have triggered the deviation in the heat exchanger parameters due to a malfunction.

For example, the fluid monitoring device 32 may monitor the level of water saturation of the fluid as the fluid flows through the heat exchanger 20 in real-time. As the level of water saturation of the fluid decreases and negatively impacts the fluid status of the fluid, an assessment of the fluid may result in a dehydration of the fluid is occurring and that the pump 12 is to be assessed as to whether the pump 12 is failing to adequately circulate the fluid throughout the working fluid system 10. In doing so, corrective action to assess the pump 12 may be executed to remedially address the decrease in the level of water saturation of the fluid as the fluid flows through the heat exchanger 20.

The fluid monitoring device 32 may monitor any type of fluid whether the fluid be liquid and/or gas that may flow through the heat exchanger 20 such that the different heat exchanger parameters may be determined. The fluid may include but is not limited to oil, lubricants, air, blood, beer and/or any other type of fluid that may be liquid and/or gas that may flow through the heat exchanger 20 that will be apparent to those skilled in the relevant art(s) without departing from the spirit and scope of the disclosure.

Further the working fluid system 10 is an example system that may incorporate the flow of fluid as well as including a heat exchanger 20 to transfer heat to or from the fluid as the fluid flows through the heat exchanger 20. However, the fluid monitoring device 32 may be incorporated into any type of working fluid system that may incorporate the flow of fluid as well as the heat exchanger 20 to transfer heat to or from the fluid as the fluid flows through the heat exchanger 20. For example, the fluid monitoring device 32 may be incorporated into industrial lubrication systems, hydraulics systems, air filtration systems, process filter systems, blood filter systems, brewing systems and/or any other type of system that may incorporate fluid flow as well as the heat exchanger 16 that will be apparent to those skilled in the relevant art(s) without departing from the spirit and scope of the disclosure.

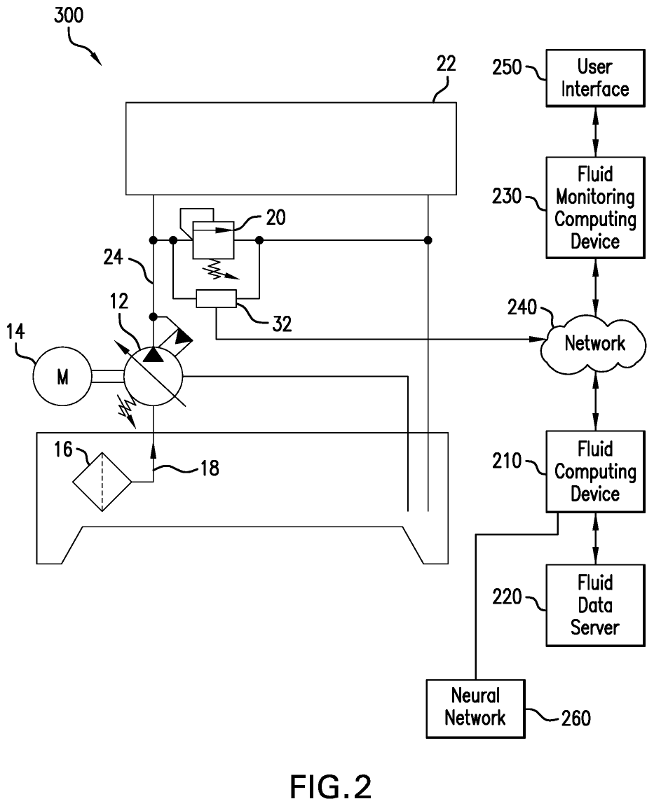

FIG. 2 illustrates a fluid computing configuration 200 in which embodiments of the present invention, or portions thereof, may be implemented. The fluid computing configuration 200 includes the working fluid system 10 as discussed in detail in FIG. 1, a fluid computing device 210, a fluid data server 220, a fluid monitoring computing device 230, a neural network 260 and a network 240. The fluid monitoring computing device 230 includes a user interface 250.

In one embodiment of the present invention, the fluid computing device 210 may communicate with the fluid monitoring device 32 to obtain heat exchanger data generated from the monitoring of the characteristics of fluid flowing through the heat exchanger 20. The fluid computing device 210 may then analyze the heat exchanger data to generate different types of analytics of the fluid as the fluid flows through the heat exchanger 20, such as whether a characteristic has exceeded a threshold, that provide insight that is easily understandable by a user as to the performance of the heat exchanger 20. The fluid computing device 210 may then communicate the analytics of the fluid as the fluid flows through the heat exchanger 20 to a fluid monitoring computing device 230 that is operated by the user so that the user may monitor the performance of the heat exchanger via the analytics provided to the user via the fluid monitoring computing device 230.

The fluid monitoring device 32 includes a microprocessor, a memory and a network interface and may be referred to as a computing device or simply “computer”. In one embodiment of the present invention, multiple modules may be implemented on the same computing device. Such a computing device may include software, firmware, hardware, or a combination thereof. Hardware can include but is not limited to, a microprocessor and/or a memory.

As the fluid monitoring device 32 monitors the heat exchanger data for each characteristic of the fluid as the fluid flows through the heat exchanger 20 of the working fluid system 10, the fluid monitoring device 32 may store the heat exchanger data in the fluid data server 220 via the network 2 40. In an embodiment, each sensor that provides a signal to the fluid monitoring device 32 may have an Internet Protocol (IP) address associated with each particular sensor. The fluid monitoring device 32 may then stream the heat exchanger data that is measured by each sensor for each characteristic that is monitored by the fluid monitoring device 32 via network 240 and then stores the heat exchanger data in the data server 220 based on the IP address of the fluid data.

The fluid computing configuration 200 may include one or more working fluid systems 10 that include one or more heat exchangers 20 and one more sensors in which each is associated with the fluid monitoring device 32 that is monitoring the fluid flow of the fluid as the fluid flows through each of the corresponding heat exchangers 20. Thus, the fluid computing configuration 200 may also include one or more fluid monitoring devices 32 dependent on the quantity of working fluid systems 10 included in the fluid computing configuration 200. Each fluid monitoring device 32 may then stream heat exchanger data for each characteristic specific to the fluid flow of the fluid as the fluid flows through the heat exchanger 20 that each fluid monitoring device 32 is monitoring via network 240 to and store the heat exchanger data in the fluid data server 220.

For example, the fluid computing configuration 200 may include a large factory that includes hundreds of sensors associated with numerous heat exchangers 20. Each of the sensors that are active in the factory and associated with a corresponding heat exchanger 20 are also associated with a fluid monitoring device 32. The fluid monitoring device 32 streams heat exchanger data for the characteristics specific to each individual sensor and stores the heat exchanger data specific to each sensor included in the factory in the fluid data server 220.

The fluid computing device 210 includes a processor, a memory, and a network interface, herein after referred to as a computing device or simply “computer”. For example, the fluid computing device 210 may include a data information system, data management system, web server, and/or file transfer server. The fluid computing device 210 may also be a workstation, mobile device, computer, cluster of computers, set-top box or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display. The fluid computing device 210 may be coupled to the fluid monitoring device 32 and/or coupled to the working fluid system 10. The fluid computing device 210 may also be positioned remote from the fluid monitoring device 32 and/or the working fluid system 10.

As the fluid computing device 210 generates the analytics of the fluid flow based on the heat exchanger data, the fluid computing device 210 may query the fluid data server 220 for the heat exchanger data associated with the characteristics that the fluid computing device 210 is to generate based on the IP address associated with the heat exchanger data. For example, the fluid computing device 210 may retrieve the heat exchanger data associated with the first pressure transducer positioned at the input of the heat exchanger 20 and the second pressure transducer positioned at the output of the heat exchanger 20 to generate the analytics of the pressure change between the first pressure transducer and the second pressure transducer based on the IP addresses associated with the heat exchanger data measured by the first pressure transducer and the second pressure transducer. The fluid computing device 210 may generate the analytics of the fluid flow for each of the heat exchangers 20 included in the fluid computing configuration 200.

The fluid monitoring computing device 230 includes a processor, a memory, and a network interface, herein after referred to as a computing device or simply “computer.” For example, the fluid monitoring computing device 230 may be a workstation, mobile device, computer, cluster of computers, or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display.

The user interface 250 may provide a user the ability to interact with the fluid monitoring computing device 230. The user interface 250 may be any type of display device including but not limited to a touch screen display, a liquid crystal display (LCD) screen, and/or any other type of display that will be apparent from those skilled in the relevant art(s) without departing from the spirit and scope of the present disclosure.

The fluid monitoring computing device 230 may be a computing device that is accessible to the user that is monitoring the performance of the heat exchanger 20. The fluid computing device 210 may stream the analytics to the fluid monitoring computing device 230 via network 240 and the fluid monitoring computing device 230 may display the analytics via the user interface 250. The fluid computing device 210 may be a stationary computing device and positioned in an office in which the user may monitor the analytics provided by the fluid computing device 210 for the fluid as the fluid flows through the heat exchanger 20. The fluid computing device 210 may also be a mobile device in which the user may be able to monitor the analytics for fluid as the fluid flows through the heat exchanger 20 as the user changes locations.

The fluid monitoring computing device 230 may display the analytics via the user interface 250 streamed by the fluid computing device 210 for the fluid in which the fluid computing device 210 has generated analytics. For example, the fluid computing configuration 200 includes a factory with hundreds of working fluid systems 10 each with heat exchangers 20. The fluid monitoring computing device 230 may display the analytics for each of the several working fluid systems 10 and corresponding heat exchangers 20 included in the fluid computing configuration 200 such that the user may monitor the performance of each fluid as the fluid flows through the heat exchanger 20, simultaneously. The fluid monitoring computing device 230 may also provide further analytics specific to a single working fluid system 10 that includes heat exchangers 20 included in the fluid computing configuration 230 when the user requests to focus in on the analytics for a single working fluid system and the corresponding heat exchangers 20 that is of interest to the user.

Wireless communication may occur via one or more networks 240 such as the internet. In some embodiments of the present invention, the network 240 may include one or more wide area networks (WAN) or local area networks (LAN). The network may utilize one or more network technologies such as Ethernet, Fast Ethernet, Gigabit Ethernet, virtual private network (VPN), remote VPN access, a variant of IEEE 802.11 standard such as Wi-Fi, and the like. Communication over the network 240 takes place using one or more network communication protocols including reliable streaming protocols such as transmission control protocol (TCP). These examples are illustrative and not intended to limit the present invention. Wired connection communication may occur with but is not limited to a fiber optic connection, a coaxial cable connection, a copper cable connection, and/or any other direct wired connection that will be apparent from those skilled in the relevant art(s) without departing from the spirit and scope of the present disclosure.

As noted above, the fluid monitoring device 32 may monitor different characteristics of the fluid flow for the working fluid system 10 as the fluid flows through the heat exchanger 20. The fluid monitoring device 32 may then provide heat exchanger data generated from the monitoring of the characteristics of the fluid flow as the fluid flows through the heat exchanger 20 by the fluid monitoring device 32 to the fluid computing device 210. The heat exchanger data is a significant amount of data generated from the monitoring of the characteristics of the fluid flow over time as the fluid flows through the heat exchanger 20 that is incorporated by the fluid computing device 210 to determine different types of analytics for the fluid. For example, the heat exchanger data includes the viscosity of the fluid. As the viscosity of the fluid increases, the fluid status of the fluid may decrease and a corrective action may be determined to provide additives to the fluid to decrease the viscosity of the fluid thereby increasing the fluid status of the fluid.

Analytics of the heat exchanger 20 that may be generated by the fluid computing device 210 incorporate the heat exchanger data for each characteristic as monitored by the fluid monitoring device 32 and from the heat exchanger data to provide insight to the performance of the heat exchanger 20 that is easily understood by the user. The amount of heat exchanger data monitored by the fluid monitoring device 32 and provided to the fluid computing device 210 may be immense. For example, the working fluid system 10 may operate for significant portions of each day and may only be taken offline for short periods of time in a given year. Thus, the amount of fluid flowing through the heat exchanger 20 may be significant as the pump 12 operates continuously for significant periods of time resulting in an immense amount of heat exchanger data for each characteristic that is monitored by the fluid monitoring device 32.

Such an immense amount of heat exchanger data monitored by the fluid monitoring device 32 and stored in the fluid data server 220 may be extremely difficult for the user to parse through to obtain an assessment of the performance of the heat exchanger 20. However, the fluid computing device 210 may analyze the immense amount of heat exchanger data and provide meaningful analytics that provide insight as to the performance of the heat exchanger 20 that are easily understood by the user.

For example, the fluid computing device 210 may generate an analytic that presents the characteristic of the water saturation in the fluid. As the water saturation increases, the fluid status of the fluid may decrease as the effectiveness of the heat exchanger 20 is decreasing. However, the increase in the water saturation may be in assessed in real-time and may be indicative water is leaking into the fluid of the fluid power system 10. In doing so, the corrective action of searching the fluid power system 10 for the source of where the water is leaking into the fluid may provide the remedial assessment that the issue triggering the increase of the water saturation level of the fluid is occurring due to water leaking into the fluid. Thus, the user may easily identify the corrective action to increase the fluid status of the fluid based on the increase in the water saturation level of the fluid.

The fluid computing device 210 may incorporate the heat exchanger data as monitored by the fluid monitoring device 32 for a particular characteristic of the fluid flow with regard to the fluid flowing through the heat exchanger 20 into an analytic such as a visual graph that depicts how the characteristic of the fluid deviates over an extended period of time as the fluid flows through the heat exchanger 20. Rather than the user having to parse through an immense amount of heat exchanger data to assess the performance of the heat exchanger 20, the fluid computing device 210 incorporates the heat exchanger data into an easily understood visual graph that provides insight to the user with regards to the performance of the heat exchanger 20.

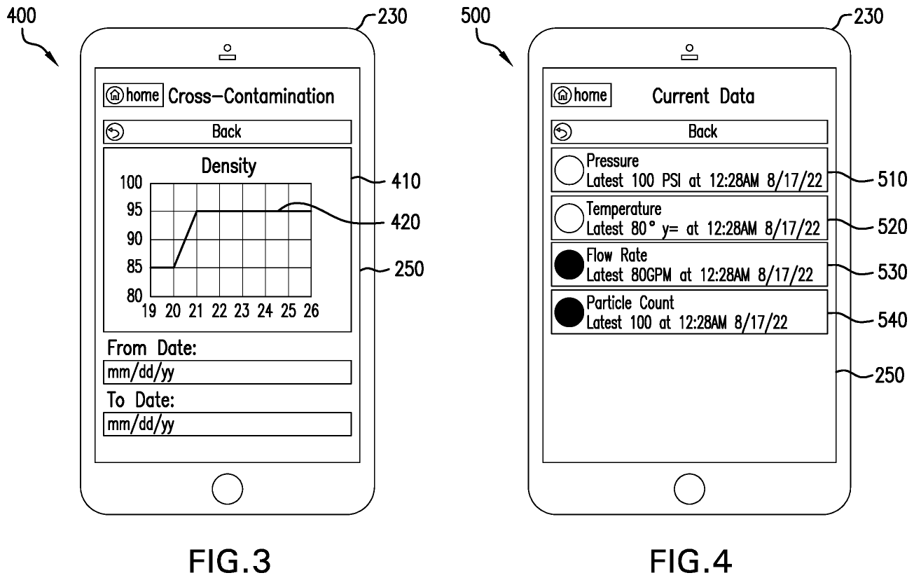

For example, FIG. 3 depicts an example visual graph configuration 300 in which the fluid monitoring computing device 230 displays a visual graph of the cross-contamination parameters of the fluid via the user interface 350 of the fluid monitoring computing device 310. The cross-contamination parameters are indicative as to a cross-contamination status as the working fluid system 10 operates. The fluid monitoring device 32 may continuously monitor the density characteristics in real-time as the working fluid system 10 operates. As the working fluid system 10 operates, one or more fluids flow through different portions of the working fluid system 10 in which each of the fluids may also flow through a corresponding heat exchanger 20. However, each of the fluids that flow through the working fluid system 10 are to remain separate and to not mix thereby generating cross-contamination of one or more of the fluids. Each of the fluids that flow through a corresponding heat exchanger 20 have a specified density. However, as one or more of the fluids mix into each other and thereby cross-contaminate, the density of the fluid that is contaminated changes due to the mixing of the fluid with another unwanted fluid.

The example visual graph configuration 300 depicted in FIG. 3 depicts how the cross-contamination parameters for the fluid have deviated over a period of time. As can be seen in FIG. 3, user interface 350 of the fluid monitoring computing device 230 depicts a visual graph 310 of the density of the fluid as the fluid flows through the working fluid system 10 over time. The density characteristic is at a lower value on the plot 320 during the initial stages of the fluid flowing through the heat exchanger 20 as the fluid is initially introduced into the heat exchanger 20 and then after a period of time the density of the fluid increases quickly and then stabilizes and continues to remain at an increased density as the fluid flows through the heat exchanger 20. In doing so, the fluid initially flowing through the heat exchanger 20 is at the appropriate density level for the fluid as specified. However, through the operation of the working fluid system 10, the fluid is cross-contaminated with a second fluid thereby triggering the quick increase in density of the fluid as the fluid flows through the heat exchanger 20. The mixing of the fluid with the unwanted second fluid changes the density of the fluid and the fluid monitoring device 32 that is monitoring the fluid as the fluid flows through the heat exchanger 20 detects the quick increase in density of the fluid.

The visual graphs of parameters and/or analytics of fluid flow that may be generated by the fluid computing device 210 may include but are not limited to temperature change, vibration, cross-contamination, magnetic flux gradient, pressure change, flow rate, volume, temperature, pump efficiency, viscosity, thermal properties, Reynolds number, particle count, relative humidity, viscosity, density, dielectric properties, AC conductivity, permittivity, pressure, wear metals level, varnish level, saturation level, and/or any other type of characteristic that may be an identifiable heat exchanger parameter of the fluid that will be apparent to those skilled in the relevant art(s) without departing from the spirit and scope of the disclosure.

The fluid computing device 210 may generate an alert and provide that alert to the user via the fluid monitoring computing device 230 when the specific heat exchanger parameter exceeds or deviates below the designated threshold of the specific characteristic. Rather than requiring the user to monitor the visual graph for each heat exchanger parameter and/or analyze other more complicated analytics generated by the fluid computing device 210, the fluid computing device 210 may generate an alert so the user is notified when any of the heat exchanger parameters have exceeded and/or have deviated below the specified threshold for each heat exchanger parameter. The user may then drill down further and request more detailed analytics but yet still be easily understandable, such as the visual graph of the failing heat exchanger parameter, to gain further analysis of what has occurred with regards to the failing fluid.

For example, the density characteristic of the fluid when initially being commissioned for the first time may have a density characteristic of 85 kg/m³ that indicates the specified density of the fluid and is the appropriate density for the fluid. As the components of the working fluid system 10 continue to operate and fluid flows through the working fluid system 10 as well as a second fluid flows through the working fluid system 10, the density characteristic may start out at 85 kg/m³ but may quickly increase to 95 kg/m³ when the fluid and the second fluid undesirably mix generating the quick increase in the density of the fluid as the fluid flows through the heat exchanger 20. The corresponding density threshold for the density characteristic when reached provides a significant indication that that the fluid has undesirably mixed with the second fluid thereby generating the quick increase in the density of the fluid as the fluid flows through the heat exchanger 20. The fluid computing device then generates an alert to the user when the density characteristic reaches the corresponding density threshold of 95 kg/m³.

In addition to simply generating the alert that the density characteristic has increased above the cross-contamination parameter threshold for the density characteristic, fluid computing device 210 may also generate an indicator in real-time that indicates the at least one component and the plurality of component characteristics that are to be targeted by the corrective action to increase the quality of the fluid. For example, the increase in the density of the fluid may be generated by a failure of a component included in the working fluid system 10. Such a failure of the component may be enabling the fluid and the second fluid to undesirably mix as the fluid and the second fluid flow through the working fluid system 10 thereby generating an increase in the density of the fluid. Rather than simply generating the alert that the density characteristic has increased above the cross-contamination threshold for the density characteristic, the fluid computing device 210 may also indicate the valve and/or pump 12 and/or heat exchanger 20 that is failing and is generating the increase in the density in the fluid. In doing so, corrective action may be taken to repair the failing component to increase the fluid status of the fluid.

The fluid computing device 210 may also provide the status of the characteristic of the flow induced vibration of the fluid as the fluid flows through the heat exchanger 20. The fluid computing device 210 may stream to the fluid monitoring computing device 230 the status of the flow induced vibration of the fluid as the fluid flows through the heat exchanger 20 with regards to whether the flow induced vibration of the fluid as the fluid flows through the heat exchanger 20 exceeded the corresponding cross-contamination parameter threshold for the flow induced vibration. As the fluid flows through the heat exchanger 20, the fluid monitoring device 32 may monitor the fluid induced vibration generated by the fluid and the fluid computing device 210 may determine whether the vibration monitored by the fluid monitoring device 32 as induced by the fluid flowing through the heat exchanger 20 is within the corresponding cross-contamination parameter threshold for the flow induced vibration. The vibration induced by the flow of the fluid through the heat exchanger 20 may be at a specified level that is the typical vibration induced by the flow of the fluid through the heat exchanger 20.

However, as the fluid undesirably mixes with a second fluid flowing through the working fluid system 10, the vibration induced by the flow of the mixed fluid flowing through the heat exchanger 20 as monitored by the fluid monitoring device 32 changes as the mixed fluid is no longer the fluid as desired to flow through the heat exchanger 20 but is rather a cross-contaminated fluid due to the undesirable mixing of the fluid and the second fluid. In doing so, the fluid computing device 210 may determine that the fluid induced vibration generated by the cross-contaminated fluid flowing through the heat exchanger 20 as measured by the fluid monitoring device 32 differs from the fluid induced vibration generated by the desired fluid flowing through the heat exchanger 20 thereby indicating that the fluid has been cross-contaminated with the second fluid.

As the flow induced vibration of the fluid increases above and/or decreases below the corresponding cross-contamination parameter threshold and continues to be above and/or below the corresponding cross-contamination parameter threshold for a period of time, such a deviation from the cross-contamination parameter threshold may be indicative that the level of the flow induced vibration may indicate that the fluid and the second fluid have undesirably mixed thereby causing the flow induced vibration of the fluid as the fluid flows through the heat exchanger 20 to deviate from the cross-contamination parameter threshold. The cross-contamination of the fluid may negatively impact the performance of the working fluid system 10 and/or the end product of the fluid that the working fluid system 10 is processing and/or producing.

The fluid computing device 210 may simplify the analytics with regards to the fluid even further from the visual graph while still providing the user with insight as to the performance of the fluid that is easily understood. As mentioned above, the user may be responsible for monitoring numerous fluids included in the fluid computing configuration 200, such as a factory that includes numerous working fluid systems 10. The user may also be responsible for many other facets of the factory in addition to the fluid and/or numerous other fluids and may not be able to routinely analyze easily understood analytics such as the visual graph and/or other easily understood analytics generated by the fluid computing device 210.

Thus, the fluid computing device 210 may simply provide the status of the fluid with regards to different characteristics of the fluid flow based on a threshold for each of the different characteristics. The fluid computing device 210 may monitor each of the different characteristics to determine whether any of the different characteristics exceeds or deviates below a threshold for the fluid. The threshold for each of the different characteristics may be customized for each specific characteristic. Each threshold may be based on a level in which the specific characteristic exceeds or deviates below and thus provides a significant indication that the performance of the fluid is degrading and requires the attention of the user.

For example, FIG. 4 depicts an example threshold alert configuration 400 in which the fluid monitoring computing device 230 displays a status of several characteristics of the fluid flow with regards to whether the characteristics have exceeded or deviated below their respective thresholds via the user interface 350. The fluid computing device 210 may stream the status of each of the characteristics of the fluid via the network 240. The status of each of the characteristics may then be displayed by the fluid computing device 210 via the user interface 350.

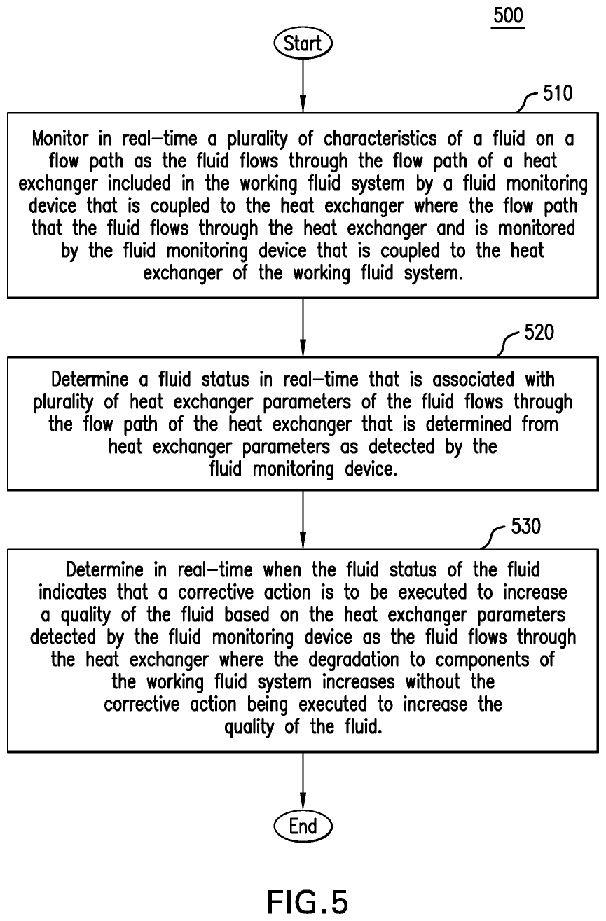

The fluid monitoring computing device 230 may depict each of the statuses by an easily recognizable identifier. With regards to the example threshold alert configuration 500 in FIG. 5, the fluid monitoring computing device 230 displays each of the statuses via the user interface 350 via two different colors. The fluid monitoring computing device 230 depicts the status of characteristic that has not exceeded or deviated below its respective threshold with the status identifier of “green” in which the color “green” is a status that is universally recognized there is no concern. The fluid monitoring computing device 230 depicts the status of the characteristic that has exceeded or deviated below its respective threshold and generates an alert with the status identifier of “red” in which the color “red” is a status that is universally recognized as there is cause for concern.

The fluid monitoring device 32 may monitor in real-time as the working fluid system 10 operates a plurality of heat exchanger parameters of the fluid. The heat exchanger parameters are indicative as to an operation status of the working fluid system 10 as the working fluid system 10 operates. The heat exchanger parameters may provide a more detailed view of the operating status of the working fluid system 10 in that the operating status of the working fluid system 10 may be an indicator as to the overall operating conditions that the working fluid system 10 is experiencing. Examples of heat exchanger parameters include but are not limited to temperature change, pressure change, cross-contamination, metallic wear debris, temperatures, pressures, flows, moistures, and/or any other heat exchanger parameter that may be monitored at the heat exchanger 20 of the working fluid system 10 but also and numerous different points throughout the working fluid system 10 that will be apparent to those skilled in the relevant art(s) without departing from the spirit and scope of the disclosure.

The fluid computing device 210 may then determine when at least one heat exchanger parameter deviates from each corresponding heat exchanger parameter threshold. The deviation of the at least one heat exchanger parameter from each corresponding heat exchanger parameter threshold is indicative that the operation status of the working fluid system 10 is requiring corrective action to increase the quality of the fluid. The fluid computing device 210 may then generate an alert when the at least one heat exchanger parameter deviates from the corresponding heat exchanger parameter threshold that is indicative that the operation status of the working fluid system 10 is requiring corrective action to increase the quality of the fluid.

For example, the example threshold alert configuration 400 in FIG. 4, provides the status of the characteristic of the pressure of the fluid. The fluid computing device 210 may stream to the fluid monitoring computing device 230 the status of the pressure of the fluid with regards to whether the pressure of the fluid has exceeded the corresponding heat exchanger parameter threshold for pressure and the fluid monitoring computing device 230 may display that status via the status pressure indicator 410. As the pressure of the fluid increases and continues to be at an increased level over a period of time, such an increase may be indicative that there may be an issue with the working fluid system 10.

Thus, the fluid computing device 210 determines whether the pressure of the fluid has reached the corresponding heat exchanger parameter threshold, and if so, streams to the fluid monitoring computing device 230 an alert that the pressure change has exceeded the corresponding heat exchanger parameter threshold for pressure. The fluid monitoring computing device 230 then displays the pressure status indicator 410 as “green” when the pressure remains below the corresponding heat exchanger parameter threshold for pressure and then displays the pressure status indicator 410 as “red” as an alert when the pressure reaches the corresponding heat exchanger parameter threshold for pressure. The fluid computing device 210 may also stream fluid data associated with the fluid to the fluid monitoring computing device 230 that the fluid monitoring computing device 230 may display. For example, the example threshold alert configuration 400 in FIG. 4, displays that the latest pressure measurement is 100 PSI and was measured at 12:28 AM on Aug. 16, 2022.

In another example, the status of the pressure of the fluid with regards to the pressure change between an inlet of the heat exchanger 20 and an outlet of the heat exchanger 20 as measured by the fluid monitoring device 32 as the fluid flows through the heat exchanger 20 may also be streamed by the fluid computing device 210 to the fluid monitoring computing device 230. The status of the pressure change as the fluid flows through the heat exchanger 20 with regard to whether the pressure of the fluid has deviated from the corresponding heat exchanger threshold for the pressure change may display the status via the status pressure indicator 410. As the pressure change of the fluid as the fluid flows through the heat exchanger 20 deviates from the heat exchanger pressure threshold for a period of time, such a deviation may be indicative that a component included in the working fluid system 10 is clogged and needs to be serviced. In such an example, the heat exchanger 20 itself may be clogged causing a deviation in pressure change between the inlet of the heat exchanger 20 and the outlet of the heat exchanger 20 from the corresponding heat exchanger parameter threshold for pressure change in which service and/or replacement of the heat exchanger 20 is required.

For example, the example threshold alert configuration 400 in FIG. 4, also provides the status of the characteristic of the temperature of the fluid. The fluid computing device 210 may stream to the fluid monitoring computing device 230 the status of the temperature of the fluid with regards to whether the temperature of the fluid has exceeded the corresponding heat exchanger parameter threshold for temperature and the fluid monitoring computing device 230 may display that status via the status temperature indicator 420. As the temperature of the fluid increases and continues to be at an increased level over a period of time, such an increase may be indicative that there may be an issue the working fluid system 20.

Thus, the fluid computing device 210 determines whether the temperature of the fluid has reached the corresponding heat exchanger parameter threshold for temperature, and if so, streams to the fluid monitoring computing device 230 an alert that the temperature has exceeded the corresponding heat exchanger parameter threshold for temperature. The fluid monitoring computing device 230 then displays the temperature status indicator 420 as “green” when the temperature remains below the corresponding heat exchanger parameter threshold for temperature and then displays the temperature status indicator 420 as “red” as an alert when the temperature reaches the corresponding heat exchanger parameter threshold for temperature. The fluid computing device 210 may also stream fluid data associated with the fluid to the fluid monitoring computing device 230 that the fluid monitoring computing device 230 may display. For example, the example threshold alert configuration 400 in FIG. 4, displays that the latest temperature measurement is 100 and was measured at 12:28 AM on Aug. 16, 2022.

In another example, the status of the temperature of the fluid with regards to the temperature change between an inlet of the heat exchanger 20 and an outlet of the heat exchanger 20 as measured by the fluid monitoring device 32 as the fluid flows through the heat exchanger 20 may also be streamed by the fluid computing device 210 to the fluid monitoring computing device 230. The status of the temperature change as the fluid flows through the heat exchanger 20 with regard to whether the temperature of the fluid has deviated from the corresponding heat exchanger threshold for the temperature change may display the status via the status temperature indicator 410. The purpose of the heat exchanger 20 as operating in the working fluid system 20 is to provide a change in temperature of the fluid as the fluid enters the inlet of the heat exchanger 20 as compared to when the fluid leaves the outlet of the heat exchanger 20. For example, the heat exchanger 20 may be designed to decrease the temperature of the fluid from 85 degrees as the fluid enters the inlet of the heat exchanger 20 to the temperature of 50 degrees as the fluid departs the outlet of the heat exchanger 20.

As the temperature change of the fluid as the fluid flows through the heat exchanger 20 deviates from the heat exchanger pressure threshold for a period of time, such a deviation may be indicative that the heat exchanger 20 is not working properly and needs to be serviced. Continuing with the example, the heat exchanger 20 as designed to decrease the temperature of the fluid from 85 degrees to 50 degrees may no longer be generating such a temperature and change and instead may only be decreasing the temperature of the fluid from 85 degrees to 70 degrees. Such a lack of a decrease of the temperature of the fluid as the fluid flows through the heat exchanger 20 may be detrimental to the operation of the working fluid system 10 and/or the fluid the working fluid system 10 is processing as a product. As a result, the fluid computing device 210 may generate an alert for the fluid monitoring computing device 230 to display to the user when the temperature change of the fluid at the inlet of the heat exchanger 20 as compared to the outlet of the heat exchanger 20 deviates beyond the heat exchanger parameter threshold for the temperature change in which the temperature of the fluid is not sufficiently changing via the heat exchanger 20.

For example, the example threshold alert configuration 400 in FIG. 4, provides the status of the characteristic of the flow rate of the fluid. The fluid computing device 210 may stream to the fluid monitoring computing device 230 the status of the flow rate with regards to whether the flow rate of the fluid as the fluid flows through the heat exchanger 20 has decreased below the corresponding heat exchanger parameter threshold for the flow rate and the fluid monitoring computing device 230 may display that status via the flow rate indicator 440. As the flow rate of the fluid as the fluid flows through the heat exchanger 20 decreases and continues to be at a decreased level over a period of time, such a decrease may be indicative that there may be an issue with one or more components of the working fluid system 10 including the heat exchanger 20 itself.

As the flow rate of the fluid as measured at the inlet and the outlet of the heat exchanger 20 by the fluid monitoring device 32 as the fluid flows through the heat exchanger 20 deviates from the heat exchanger parameter threshold for flow rate over a period of time, such a deviation may be indicative that a component included in the working fluid system 10 is clogged and needs to be serviced. For example, the heat exchanger 20 is designed to enable the fluid to flow through the heat exchanger 20 at a specified flow rate of 80 GPMs. However, the fluid computing device 210 determines that the flow rate of the fluid as the fluid flows through the heat exchanger 20 is at a flow rate of 50 GPMs which is a significant decrease in the flow rate in which the fluid should be flowing through the heat exchanger 20. In such an example, the heat exchanger 20 itself may be clogged causing a decrease in flow rate between the inlet of the heat exchanger 20 and the outlet of the heat exchanger 20 from the corresponding heat exchanger parameter threshold for flow rate in which service and/or replacement of the heat exchanger 20 is required.

Thus, the fluid computing device 210 determines whether the flow rate of the fluid has reached the corresponding heat exchanger parameter threshold for the flow rate of the fluid through the heat exchanger 20, and if so, streams to the fluid monitoring computing device 230 an alert that the flow rate has exceeded the corresponding heat exchanger parameter threshold for flow rate. The fluid monitoring computing device 230 then displays the flow rate status indicator 440 as “green” when the flow rate remains above the corresponding heat exchanger parameter threshold for flow rate and then displays the flow rate status indicator 440 as “red” as an alert when the flow rate reaches the corresponding heat exchanger parameter threshold for the flow rate. The fluid computing device 210 may also stream fluid data associated with the fluid to the fluid monitoring computing device 230 that the fluid monitoring computing device 230 may display. For example, the example threshold alert configuration 400 in FIG. 4, displays that the latest flow rate measurement is 80 GPMs and was measured at 12:28 AM on Aug. 16, 2022.

The fluid monitoring device 32 may monitor in real-time as the working fluid system 10 operates a plurality of particle count characteristics of the fluid by the fluid monitoring device 32 as the fluid flows through the inlet and the outlet of the heat exchanger 20. The particle counting characteristics are indicative as to a particle count status of the fluid as the working fluid system 10 operates. The particle counting characteristics may provide trending of particle ingression into the fluid as operating and/or environmental conditions of the working fluid system 10 change based on the monitoring of the particle count as the fluid flows through the heat exchanger 20.

The fluid monitoring device 32 may then determine when at least one particle counting characteristic deviates from the metallic wear debris parameter threshold for each corresponding particle count characteristic as the fluid flows through the heat exchanger 20. The deviation of the at least one particle count characteristic from the metallic wear debris parameter threshold for the corresponding particle count characteristic is indicative that a quantity of particles included in the fluid is increasing as the fluid flows through the heat exchanger 20. The fluid computing device 210 may generate the alert when the at least one particle counting characteristic deviates from the metallic wear debris parameter threshold for the corresponding particle counting characteristic that is indicative that the quantity of particles included in the fluid is increasing and is requiring corrective action to increase the quality of the fluid.

For example, the example threshold alert configuration 400 in FIG. 4, provides the status of the characteristic of the particle count of the fluid as the fluid flows through the heat exchanger 20. The fluid computing device 210 may stream to the fluid monitoring computing device 230 the status of the particle count with regards to whether the particle count of the fluid has exceeded the metallic wear debris parameter threshold for the particle count characteristic and the fluid monitoring computing device 210 may display that status via the status particle count indicator 430. As the particle count of the fluid increases as the fluid flows through the heat exchanger 20 and continues to be at an increased level over a period of time, such an increase may be indicative that there may be an issue with contaminant egress, machine wear, and/or the fluid is possibly failing.

Thus, the fluid computing device 210 determines whether the particle count of the fluid has reached the metallic wear debris parameter threshold for the particle count characteristic, and if so, streams to the fluid monitoring computing device 230 an alert that the particle count has exceeded the metallic wear debris threshold for the particle count characteristic. The fluid monitoring computing device 230 then displays the particle count status indicator 430 as “green” when the particle count remains below the metallic wear debris threshold for the particle count characteristic as the fluid flows through the heat exchanger 20 and then displays the particle count status indicator 430 as “red” as an alert when the particle count reaches the metallic wear debris parameter threshold for the particle count characteristic. The fluid computing device 210 may also stream fluid data associated with the fluid to the fluid monitoring computing device 230 that the fluid monitoring computing device 230 may display. For example, the example threshold alert configuration 400 in FIG. 4, displays that the latest particle count measurement is 3.3 and was measured at 12:28 AM on Aug. 16, 2022.

In addition to generating the alert that the particle count of the working fluid system 10 has exceeded the corresponding particle count parameter threshold, the fluid computing device 210 may also assess in real-time the increase in particle count and determine at least one component that may be triggering the increase in particle count due to malfunctioning of the component. The fluid computing device 210 may then generate an indicator in real-time that indicates the at least one component and the component characteristics of the at least one component that could be triggering the increase in particle count. For example, the fluid computing device 210 may identify that the breather of the working fluid system 10 is failing and such a failure in the breather is triggering the increase in the particle count of the fluid. The fluid computing device 210 may then generate an indicator in real-time to the fluid monitoring computing device 230 that indicates that correction action should be executed to address the breather.

The fluid computing device 210 may alert several different users that may have interest when the different heat exchanger parameters of the fluid deviate from the corresponding thresholds. For example, the fluid computing device 210 may alert the maintenance manager via the fluid monitoring computing device 230 of the maintenance manager. The fluid computing device 210 may alert the purchase department via the fluid monitoring computing device 230 of the purchase department. The fluid computing device 210 may alert the new order supply chain of the magnetic fluid filter distributor via the fluid monitoring computing device 230 of the magnetic fluid filter distributor. The fluid computing device 210 may alert the sales person of the magnetic fluid filter distributor via the fluid monitoring computing device 230.

The fluid computing device 210 may alert any user that has an interest in the fluid via the corresponding fluid monitoring computing device 230 when the heat exchanger parameters of the fluid deviate from the corresponding thresholds that will be apparent to those skilled in the relevant art(s) without departing from the spirit and scope of the disclosure. The fluid computing device 210 may generate the alert to be displayed to the user via the fluid monitoring computing device 230 via Short Message Service (SMS) messaging, electronic mail, short range wireless communications, Multimedia Messaging Service (MMS) messaging, an Application Programming Interface (API) call and/or any other suitable communication approach that will be apparent to those skilled in the relevant art(s) without departing from the spirit and scope of the present disclosure.

In an embodiment, the fluid computing device 210 may generate the alert and provide the alert to an Enterprise Resource Planning (ERP) system of the maintenance team that is responsible for replacing the heat exchanger 20 when the heat exchanger parameters of the fluid deviate from the corresponding thresholds. In doing so, the fluid computing device 210 may automatically alert the ERP that the heat exchanger 20 has issues and requires replacement. The ERP may then automatically generate an order for a new heat exchanger to replace the heat exchanger 20 that has deviated from the thresholds and provide the order to the heat exchanger distributor. The heat exchanger distributor may then ship the new heat exchanger 20 such that the heat exchanger 20 that has deviated from the thresholds may be replaced without a disruption in down time for the working fluid system 10.

In an embodiment, the fluid monitoring device 32 may continuously monitor the characteristics as the fluid flows through the heat exchanger 20. The fluid computing device 210 may then forecast a plurality of prediction dates associated with the heat exchanger parameters of the fluid as the fluid flows through the heat exchanger 20 and monitored by the fluid monitoring device 32. Each prediction date predicts a field status of the fluid to indicate that a corresponding corrective action is to be executed to prevent degradation to the at least one component that is determined from the corresponding heat exchanger parameters detected by the fluid monitoring device 32. As the fluid monitoring device 32 continuously monitors the fluid as the fluid flows through the heat exchanger 20 for a period of time, the fluid computing device 210 is determining when and how often the heat exchanger parameters are deviating from the corresponding heat exchanger parameter thresholds. In doing so, the fluid computing device 210 may then forecast prediction dates based on the heat exchanger parameters as to when specific components of the working fluid system 10 should be scheduled for corresponding corrective actions.

For example, as the fluid monitoring device 32 continuously monitors the fluid as the fluid flows through the heat exchanger 20 for a period of time, the fluid computing device 210 is determining when and how often each heat exchanger parameter deviates from the corresponding heat exchanger parameter threshold. In such an example, the fluid computing device 210 may determine when the flow rate of the fluid is decreasing below the corresponding heat exchanger parameter threshold for flow rate. After the first time the first time that the fluid computing device 210 determines that the flow rate of the fluid has decreased below the heat exchanger parameter threshold for the flow rate, the fluid computing device 210 may determine that the corrective action of a cleaning of the heat exchanger 20 by the user is required.

As the heat exchanger 20 then continues to operate after the first corrective action of cleaning the heat exchanger 20 by the user, the fluid computing device 210 may then forecast various prediction dates as to the service that the heat exchanger 20 may require as the heat exchanger 20 continues to operate. In such an example, the fluid computing device 210 may forecast when each subsequent cleaning by the user is required. The fluid computing device 210 may forecast when each servicing by the distributor of the heat exchanger 20 is required. Ultimately, the fluid computing device 210 may forecast when the heat exchanger 20 is to be replaced. Each time that the flow rate of the heat exchanger 20 and/or any other heat exchanger parameter deviates below the corresponding heat exchanger parameter threshold, the fluid computing device 210 may adjust the forecast of each servicing and the ultimate replacement of the heat exchanger 20, accordingly.

In an embodiment, a neural network 260 may assist the fluid computing device 210 in forecasting prediction dates associated with the heat exchanger parameters of the fluid. Each prediction date predicts when the field status of the fluid is to indicate that a corresponding corrective action is to be executed to increase the quality of the fluid that is determined from the corresponding heat exchanger parameters detected by the fluid monitoring device 32.

The fluid computing device 210 may accumulate the different heat exchanger parameters of the fluid as the fluid continuously flows through the heat exchanger 20. As fluid continuously flows through the heat exchanger 20, the fluid computing device 210 may accumulate the different changes in each of the different heat exchanger parameters of the fluid as the fluid continuously flows through working fluid system 10. In accumulating the different changes in the heat exchanger parameters of the fluid as the fluid continuously flows through the working fluid system 10, such an accumulation of the different changes in the heat exchanger parameters may be stored in fluid data server 220.

The fluid computing device 210 may then determine prediction dates for each of the different corrective actions that may be executed to increase the quality of the fluid. The accumulation of the changes in the different heat exchanger parameters of the fluid as the fluid continuously flows through the heat exchanger 20 that is stored in the fluid data server 220 may then be applied to the neural network 260. The neural network 260 may apply a neural network algorithm such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

In doing so, the neural network 260 may then assist the fluid computing device 210 in forecasting the different prediction dates for each of the different corrective actions that are to be executed to increase the quality of the fluid based on the accumulated changes in the different heat exchanger parameters of the fluid as the fluid continuously flows through the heat exchanger 20. Each time that the different heat exchanger parameters of the fluid change as the fluid continuously flows through the heat exchanger 20, the neural network 260 may continue to accumulate each of the monitored changes in the different heat exchanger parameters to further improve the accuracy of the fluid computing device 210 in determining the different prediction dates for each of the different corrective actions. In doing so, the neural network 260 may provide the forecast of the different prediction dates that each of the corrective actions are to be executed to the fluid computing device 210 and the fluid computing device 210 may generate the different prediction dates with increased accuracy as the changes in the different heat exchanger parameters of the fluid as the fluid continues to flow through the heat exchanger 20 is accumulated. The fluid computing device 210 may then continue to learn.

The neural network 260 may also assist the fluid computing device 210 in determining the appropriate corrective action to execute when several of the heat exchanger parameters indicate that different corrective actions may be executed to increase the quality of the fluid. Rather than the user having to pursue each different corrective action to determine whether each corrective action increases the quality of the fluid, the neural network 260 may assist the fluid computing device 210 to determine which corrective action to recommend to the user as compared to the other corrective actions that may be triggered due to the different heat exchanger parameters deviating from their respective thresholds. The fluid data for associated with each possible corrective action may be accumulated as different corrective actions are triggered based on the different heat exchanger parameters deviating from their respective thresholds. The fluid data may be data that is generated after each time the corrective action is executed and the impact to the quality of the fluid and the different heat exchanger parameters is determined.

As the neural network 260 learns with the fluid data that is continuously accumulated as the different corrective actions are executed and the corresponding impact to the quality of the fluid and the different heat exchanger parameters is determined, the neural network 260 may assist the fluid computing device 210 in evaluating the appropriate corrective action to execute when different corrective actions may be triggered based on numerous heat exchanger parameters deviating from their corresponding thresholds.

For example, the fluid monitoring device 32 may detect an instant fluctuation in flow induced vibration of the fluid as the fluid flows through the heat exchanger 20 which may be indicative that the fluid has been cross-contaminated with a second fluid. In doing so, several different corrective actions may be triggered based on the instant fluctuation in the flow induced vibration. Rather than having the user execute each of the different corrective actions to increase the quality of the fluid and to stabilize the flow induced vibration of the fluid within the cross-contamination parameter threshold for vibration, the neural network 260 based on the execution of past corrective actions and the impact on the corresponding flow induced vibration of the fluid and corresponding stabilization of the flow induced vibration of the fluid to be within the cross-contamination parameter threshold for the flow induced vibration may assist the fluid computing device 210 in determining the appropriate corrective action for the user to execute.

Referring now to FIG. 5, a flowchart is presented showing an exemplary process 500 for determining a heat exchanger efficiency of a fluid that flows through a heat exchanger included in a working fluid system. As shown in FIG. 5, process 500 begins at step 510, when a plurality of characteristics of a fluid on a flow path as the fluid flows through the flow path of the heat exchanger included in the working fluid system by a fluid monitoring device that is coupled to the heat exchanger. The flow path is a path that the fluid flows through the fluid monitoring device that is coupled to the heat exchanger and is monitored by the fluid monitoring device that is coupled to the heat exchanger as the fluid flows through the heat exchanger of the working fluid system. For example, as shown in FIG. 3, the fluid monitoring device 32 may monitor characteristics of a fluid generated by the heat exchanger 20 positioned on a flow path as the fluid flows through the heat exchanger 20 with the fluid monitoring device 32 coupled to the heat exchanger 20. The flow path is a path that the fluid flows through the fluid monitoring device 32 and the heat exchanger 20 as the fluid flows through the working fluid system 10. As the characteristics of the fluid are monitored, the system may proceed to step 520 of process 500.

At step 520 of process 500, a fluid status is determined in real-time that is associated with a plurality of heat exchanger parameters of the fluid as the fluid flows through the flow path of the heat exchanger that is determined from a plurality of heat exchanger parameters detected by the fluid monitoring device. For example, as shown in FIG. 3, the fluid computing device 210 determines whether the fluid status of the fluid is indicative of a decreased quality of the fluid based on the heat exchanger parameters of the fluid as fluid flows through the fluid monitoring device 32. The system may then proceed to step 530 of process 500.

At step 530 of process 500, the fluid status of the fluid is determined in real-time when the fluid status of the fluid indicates that a corrective action is to be executed to increase a quality of the fluid based on the heat exchanger parameters detected by the fluid monitoring device as the fluid flows through the heat exchanger. Degradation to components of the working fluid system increases without the corrective action being executed to increase the quality of the fluid. For example, as shown in FIG. 2, the fluid computing device 210 determines in real-time when the fluid status of the fluid indicates that a corrective action is to be executed to increase the quality of the fluid, such as evaluating the whether different components are clogged, and generating an assessment of the corrective action, such as which component is clogged, based on the deviation of heat exchanger parameters from the corresponding heat exchanger parameter threshold generated by the fluid as the fluid flows through the heat exchanger 20. The degradation to the components and/or the fluid of the working fluid system 10 increases as the fluid flows through the working fluid system 10 without addressing the clogging of the particular component.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination.

Additional advantages and modifications will readily appear to those skilled in the art. The invention in its broader aspects is therefore not limited to the specific details and representative devices shown and described. Accordingly, departures may be made from such details without departing from the scope of the general inventive concept.

What is claimed is:

1. A computer implemented method for determining a heat exchanger efficiency of a fluid that flows through a heat exchanger included in a working fluid system, comprising:
monitoring in real-time a plurality of characteristics of a fluid on a flow path as the fluid flows through the flow path of a heat exchanger included in the working fluid system by a fluid monitoring device that is coupled to the heat exchanger, wherein the flow path is a path that the fluid flows through the heat exchanger and is monitored by the fluid monitoring device that is coupled to the heat exchanger as the fluid flows through the heat exchanger of the working fluid system;
determining a fluid status in real-time that is associated with a plurality of heat exchanger parameters of the fluid as the fluid flows through the flow path of the heat exchanger that is determined from the plurality of heat exchanger parameters detected by the fluid monitoring device; and
determining in real-time when the fluid status of the fluid indicates that a corrective action is to be executed to increase a quality of a fluid based on the heat exchanger parameters detected by the fluid monitoring device as the fluid flows through the heat exchanger, wherein degradation to components of the working fluid system increases as the fluid flows through the heat exchanger without the corrective action being executed to increase the quality of the fluid.

2. The computer implemented method of claim 1, further comprising:
assessing in real-time the characteristics and the heat exchanger parameters that are triggered from the characteristics of the fluid as the fluid flows through the heat exchanger as the working fluid system operates to determine at least one component and a plurality of component characteristics associated with the at least one component that are impacted by the heat exchanger parameters; and
generating an indicator in real-time that indicates the at least one component and the plurality of component characteristics that are to be targeted by the corrective action to prevent degradation to the at least one component.

3. The computer implemented method of claim 2, further comprising:
generating an alert when the fluid status for the fluid indicates that the corrective action is to be executed to prevent degradation to the at least one component and providing the assessment of the corrective action that is to be executed based on the heat exchanger parameters detected by the fluid monitoring device.

4. The computer implemented method of claim 3, further comprising: monitoring:
monitoring in real-time as the working fluid system operates a plurality of heat exchanger parameters of the fluid at the first point and the second point on the flow path of the heat exchanger by the fluid monitoring device, wherein the heat exchanger parameters are indicative as to an operation status of the working fluid system as the working fluid system operates;
determining when at least one heat exchanger parameter deviates from each corresponding heat exchanger parameter threshold, wherein the deviation of the at least one heat exchanger parameter from each corresponding heat exchanger threshold is indicative that the operation status of the working fluid system is requiring corrective action to prevent degradation to the at least one component included in the working fluid system;
generating the alert when the at least one heat exchanger parameter deviates from the corresponding heat exchanger parameter threshold that is indicative that the operation status of the working fluid system is requiring corrective action to prevent degradation to the at least one component included in the working fluid system.

5. The computer implemented method of claim 3, further comprising:
monitoring in real-time as the working fluid system operates a temperature parameter of the fluid at the first point and the second point on the flow path of the heat exchanger by the fluid monitoring device, wherein the temperature parameter is indicative as to a temperature status of the fluid as the working fluid system operates;
determining when the at least one temperature parameter deviates from the corresponding temperature parameter threshold, wherein the deviation of the temperature parameter from the temperature parameter threshold is indicative that degradation to the at least one component is occurring and is requiring corrective action to prevent the degradation; and
generating the alert when the temperature parameter deviates from the temperature parameter threshold that is indicative that degradation to the at least one component is occurring and is requiring corrective action to prevent the degradation.

6. The computer implemented method of claim 3, further comprising:
monitoring in real-time as the working fluid system operates a pressure parameter of the fluid at the first point and the second point on the flow path of the heat exchanger by the fluid monitoring device, wherein the pressure parameter is indicative to a pressure status of the fluid as the working fluid system operates;
determining when the pressure parameter deviates from the corresponding pressure parameter threshold, wherein the deviation of the pressure parameter threshold from the pressure parameter threshold is indicative that degradation to the at least one component is occurring and is requiring corrective action to prevent the degradation; and
generating the alert when the pressure parameter deviates from the pressure parameter threshold that is indicative that degradation to the at least one component is occurring and is requiring corrective action to prevent the degradation.

7. The computer implemented method of claim 3, further comprising: monitoring in real-time as the working fluid system operates a cross-contamination parameter of the fluid at the first point and the second point on the flow path of the heat exchanger by the fluid monitoring device, wherein the cross- contamination parameter is indicative as to whether cross-contamination is occurring to the fluid as the working fluid system operates;
determining when the cross-contamination parameter deviates from the cross-contamination parameter threshold, wherein the deviation of the cross-contamination parameter from the cross-contamination parameter threshold is indicative that cross-contamination of the fluid is increasing; and
generating the alert when the cross-contamination parameter deviates from the cross-contamination parameter threshold that is indicative that cross-contamination of the fluid is increasing.

8. The computer implemented method of claim 3, further comprising:
monitoring in real-time as the working fluid system operates a flow rate parameter of the fluid at the first point and the second point on the flow path of the heat exchanger by the fluid monitoring device, wherein the flow rate parameter is indicative to a pressure status of the fluid as the working fluid system operates;
determining when the flow rate parameter deviates from the flow rate parameter threshold, wherein the deviation of the flow rate parameter from the flow rate parameter threshold is indicative that degradation to the at least one component is occurring and is requiring corrective action to prevent the degradation; and
generating the alert when the flow rate parameter deviates from the flow rate parameter threshold that is indicative that degradation to the at least one component is occurring and is requiring corrective action to prevent the degradation.

9. The computer implemented method of claim 1, further comprising:
generating a visual graph that depicts how the characteristics deviate for the heat exchanger over an extended period of time.

10. The computer implemented method of claim 3, further comprising:
continuously monitoring the characteristics as the fluid flows through the heat exchanger as monitored by the by the fluid monitoring device;
forecasting a plurality of prediction dates associated with the heat exchanger parameters of the fluid as the fluid flows through the heat exchanger and monitored by the fluid monitoring device, wherein each prediction date predicts a field status of the fluid to indicate that a corresponding corrective action is to be executed to prevent degradation to the at least one component that is determined form the corresponding heat exchanger parameters detected by the fluid monitoring device; and
generating a plurality of alerts to indicate each prediction date that the corresponding corrective action is to be executed to prevent degradation to the at least one component.

11. A system for determining a heat exchanger efficiency of a fluid that flows through a heat exchanger included in a working fluid system, comprising:
a fluid monitoring device that is coupled to the heat exchanger and is configured to monitor in real-time a plurality of characteristics of a fluid on a flow path as the fluid flows through the flow path of the heat exchanger included in the working fluid system, wherein the flow path is a path that the fluid flows through the heat exchanger and is monitored by the fluid monitoring device as the fluid flows through the heat exchanger of the working fluid system;
a fluid computing device that is configured to:
determine a fluid status in real-time that is associated with a plurality of heat exchanger parameters of the fluid as the fluid flows through the flow path of the heat exchanger that is determined from the plurality of heat exchanger parameters detected by the fluid monitoring device, and
determine in real-time when the fluid status of the fluid indicates that a corrective action is to be executed to increase a quality of a fluid based on the heat exchanger parameters detected by the fluid monitoring device, wherein degradation to components of the working fluid system increases as the fluid flows through the heat exchanger without the corrective action being executed to increase the quality of the fluid.

12. The system of claim 11, wherein the fluid computing device is further configured to:
assess in real-time the characteristics and the heat exchanger parameters that are triggered from the characteristics of the fluid as the fluid flows through the heat exchanger as the working fluid system operates to determine at least one component and a plurality of component characteristics associated with the at least one component that are impacted by the heat exchanger parameters; and
generate an indicator in real-time that indicates the at least one component and the plurality of component characteristics that are to be targeted by the corrective action to prevent degradation to the at least one component.

13. The system of claim 12, wherein the fluid computing device is further configured to:
generate an alert when the fluid status of the fluid indicates that the corrective action to be executed to prevent degradation to the at least one component and provide the assessment of the corrective action that is to be executed based on the heat exchanger parameters detected by the fluid monitoring device.

14. The system of claim 13, wherein the fluid monitoring device is further configured to:
monitor in real-time as the working fluid system operates the plurality of heat exchanger parameters of the fluid at a first point and a second point on the flow path of the heat exchanger, wherein the heat exchanger parameters are indicative as to an operation status of the working fluid system as the working fluid system operates.

15. The system of claim 14, wherein the fluid computing device is further configured to:
determine when at least one heat exchanger parameter deviates from each corresponding heat exchanger parameter threshold, wherein the deviation of the at least one heat exchanger parameter from each corresponding heat exchanger threshold is indicative that the operation status of the working fluid system is requiring corrective action to prevent degradation to the at least one component included in the working fluid system; and
generate the alert when the at least one heat exchanger parameter deviates from the corresponding heat exchanger parameter threshold that is indicative that the operation status of the working fluid system is requiring corrective action to prevent degradation to the at least one component included in the working fluid system.

16. The system of claim 13, wherein the fluid monitoring device is further configured to:
monitor in real-time as the working fluid system operates a temperature parameter of the fluid at the first point and the second point on the flow path of the heat exchanger, wherein the temperature parameter is indicative as to a temperature status of the fluid as the working fluid system operates.

17. The system of claim 16, wherein the fluid computing device is further configured to:
determine when the at least one temperature parameter deviates from the corresponding temperature parameter threshold, wherein the deviation of the temperature parameter from the temperature parameter threshold is indicative that degradation to the at least one component is occurring and is requiring corrective action to prevent the degradation; and
generate the alert when the temperature parameter deviates from the temperature parameter threshold that is indicative that degradation to the at least one component is occurring and is requiring corrective action to prevent the degradation.

18. The system of claim 13, wherein the fluid monitoring device is further configured to:
monitor in real-time as the working fluid system operates a pressure parameter of the fluid at the first point and the second point on the flow path of the heat exchanger, wherein the pressure parameter is indicative to a pressure status of the fluid as the working fluid system operates.

19. The system of claim 18, wherein the fluid computing device is further configured to:
determine when the pressure parameter deviates from the pressure parameter threshold, wherein the deviation of the pressure parameter threshold, wherein the deviation of the pressure parameter threshold is indicative that degradation to the at least one component is occurring and is requiring corrective action to prevent the degradation; and
generate the alert when the pressure parameter deviates from the pressure parameter threshold that is indicative that degradation to the at least one component is occurring and is requiring corrective action to prevent the degradation.

20. The system of claim 13, wherein the fluid monitoring device is further configured to:
monitor in real-time as the working fluid system operates a cross-contamination parameter of the fluid at the first point and the second point of the flow path of the heat exchanger, wherein the cross-contamination parameter is indicative as to whether cross-contamination is occurring in the fluid as the working fluid system operates.

21. The system of claim 20, wherein the fluid computing device is further configured to:
determine when the cross-contamination parameter deviates from the cross-contamination parameter threshold, wherein the deviation of the cross- contamination parameter from the cross-contamination parameter threshold is indicative that cross-contamination of the fluid is increasing; and
generate the alert when the cross-contamination parameter deviates from the cross-contamination parameter threshold that is indicative that cross-contamination of the fluid is increasing.

22. The system of claim 13, wherein the fluid monitoring device is further configured to:
monitor in real-time as the working fluid system operates a flow rate parameter of the fluid at the first point and the second point on the flow path of the heat exchanger, wherein the flow rate parameter is indicative to a flow rate status of the fluid as the working fluid system operates.

23. The system of claim 22, wherein the fluid computing device is further configured to:
determine when the flow rate parameter deviates from the flow rate parameter threshold, wherein the deviation of the flow rate parameter from the flow rate parameter threshold is indicative that degradation to the at least one component is occurring and is requiring corrective action to prevent the degradation; and
generate the alert when the flow rate parameter deviates from the flow rate parameter threshold that is indicative that degradation to the at least one component is occurring and is requiring corrective action to prevent the degradation.

24. The system of claim 11, wherein the fluid computing device is further configured to generate a visual graph that depicts how the characteristics deviate for the heat exchanger over an extended period of time.

25. The system of claim 13, wherein fluid monitoring device is further configured to:
continuously monitor the characteristics as the fluid flows through the heat exchanger.

26. The system of claim 25, wherein the fluid computing device is further configured to:
forecast a plurality of prediction dates associated with the heat exchanger parameters of the fluid as the fluid flows through the heat exchanger and monitored by the fluid monitoring device, wherein each prediction date predicts a field status of the fluid to indicate that a corresponding corrective action is to be executed to prevent degradation to the at least one component that is determined from the corresponding heat exchanger parameters detected by the fluid monitoring device; and
generate a plurality of alerts to indicate each prediction date that the corresponding corrective action is to be executed to prevent degradation to the at least one component.
